(19) United States
(12) Patent Application Publication
(10) Pub. No.: US 2025/0261008 A1
(43) Pub. Date: Aug. 14, 2025

(54) ENHANCED RRM MEASUREMENTS FOR LATENCY-SENSITIVE TRAFFIC

(71) Applicant: QUALCOMM Incorporated, San Diego, CA (US)

(72) Inventors: Mickael MONDET, Louannec (FR); Hyun Yong LEE, San Diego, CA (US); Diana MAAMARI, San Diego, CA (US); Prashanth Haridas HANDE, San Diego, CA (US)

(21) Appl. No.: 18/439,230

(22) Filed: Feb. 12, 2024

(51) Int. Cl. H04W 24/08; H04W 24/10

(52) U.S. Cl. CPC H04W 24/08; H04W 24/10

(57) ABSTRACT

Certain aspects of the present disclosure provide techniques for enhanced radio resource management (RRM) measurements for latency-sensitive traffic. A method performed by a network entity may include transmitting, to a user equipment (UE), configuration information indicating: one or more neighbor cells for which to perform RRM measurements and a measurement gap configuration indicating one or more measurement gaps for performing the RRM measurements. The network entity may receive one or more resource status reports from the one or more neighbor cells, indicating an amount of resources being used at a respective neighbor cell of the one or more neighbor cells. The network entity may transmit, to the UE based on the one or more resource status reports received from the one or more neighbor cells, a message indicating an activation status associated with at least one of the RRM measurements or the one or more measurement gaps.

### BACKGROUND

### Field of the Disclosure

Aspects of the present disclosure relate to wireless communications, and more particularly, to techniques for radio resource management (RRM) measurement enhancements for latency-sensitive traffic.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a network entity associated with a serving cell. The method includes transmitting, to a user equipment (UE), configuration information indicating: one or more neighbor cells for which to perform radio resource management (RRM) measurements; and a measurement gap configuration indicating one or more measurement gaps for performing the RRM measurements; receiving one or more resource status reports from the one or more neighbor cells, wherein each resource status report of the one or more resource status reports indicates an amount of resources being used at a respective neighbor cell of the one or more neighbor cells from which that resource status report is received; and transmitting, to the UE based on the one or more resource status reports received from the one or more neighbor cells, a message indicating an activation status associated with at least one of the RRM measurements or the one or more measurement gaps.

Another aspect provides a method for wireless communication by a UE. The method includes receiving, from a network entity associated with a serving cell, configuration information indicating: one or more neighbor cells for which to perform RRM measurements; and a measurement gap configuration indicating one or more measurement gaps for performing the RRM measurements; receiving, from the network entity, a message indicating an activation status associated with at least one of the RRM measurements or the one or more measurement gaps, wherein the message indicating the activation status is based on one or more resource status reports associated with the one or more neighbor cells; and taking one or more actions based on the message indicating the activation status associated with at least one of the RRM measurements or the one or more measurement gaps.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example extended reality (XR) scenario.

FIG. 6A and FIG. 6B depict example measurement gap configurations.

FIG. 7 depicts an example of the potential impact of measurement gaps on burst traffic.

FIG. 8 depicts a process flow for communications in a network between a first network entity associated with a source cell, a user equipment, and one or more neighbor cells.

FIG. 9 depicts a method for wireless communications.

FIG. 10 depicts a method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for enhanced radio resource management (RRM) measurements for latency-sensitive traffic.

For example, in 5G NR systems, a UE operating in multi-frequency cellular networks is typically configured with measurement gaps, in which the UE intermittently suspends data transmission to perform radio resource management (RRM) measurements for neighboring cells. These RRM measurements may be provided to a serving cell of the UE and used to make handover decisions for the UE. In other words, the serving cell may use the RRM measurements to decide whether to hand the UE over to one of the neighboring cells that may be better suited to serve the UE.

In some cases, these measurement gaps may be problematic for certain types of traffic, such as latency sensitive multimedia data traffic (e.g., extended reality (XR), virtual reality (VR), augmented reality (AR), etc.), which are expected to be delivered within a certain packet delay budget (e.g., 10 ms). For example, because the measurement gap has a higher priority than the normal data traffic in current systems, the UE may be unable to receive or transmit any traffic data during a time period corresponding to the measurement gaps. As such, the measurement gaps may increase the transmission time for the latency sensitive multimedia data traffic, making it difficult to meet the PDB requirements for this traffic.

Additionally, while the RRM measurements and measurement gaps serve an important purpose (e.g., allowing the UE to be handed over to a neighbor cell that is better suited to serve the UE), there may be scenarios in which one or more neighbor cells that the UE is configured to perform the RRM measurements for is heavily loaded and unable to serve the UE. In such cases, since the one or more neighbor cells are unable to serve the UE, performing the RRM measurements during one or more measurement gaps for these neighbor cells would be counterproductive and would unnecessarily delay communication of the latency sensitive multimedia data traffic, leading to poor user experience.

Accordingly, aspects of the present disclosure provide techniques for improving RRM measurements for latency-sensitive multimedia data traffic described above. For example, in some cases, rather that forcing a UE to perform RRM measurements for every neighbor cell, performance of these RRM measurements may be based, for example, on resource status reports of the neighbor cells. More specifically, for example, a network entity of a serving cell of the UE may receive one or more resource status reports from one or more neighbor cells of the UE, which may indicate an amount of resources being used at a respective neighbor cell of the one or more neighbor cells from which the resource status reports are received. The network entity of the serving cell may then transmit, to the UE based on the one or more resource status reports received from the one or more neighbor cells, a message indicating an activation status associated with at least one of the RRM measurements or the one or more measurement gaps.

In some cases, the UE may be able to refrain from performing one or more RRM measurements when the activation status indicates that at least one of the RRM measurements or the one or more measurement gaps are deactivated. Deactivating certain RRM measurements and/or measurement gaps may reduce the impacts that the measurement gaps and RRM measurements have on the transmission time of the latency-sensitive multimedia data traffic and may, thus, improve user experience related to latency-sensitive services. For example, the fewer RRM measurements the UE has to perform, the less often the UE needs the measurement gaps, resulting in the latency-sensitive multimedia data traffic being subject to less interruption time.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

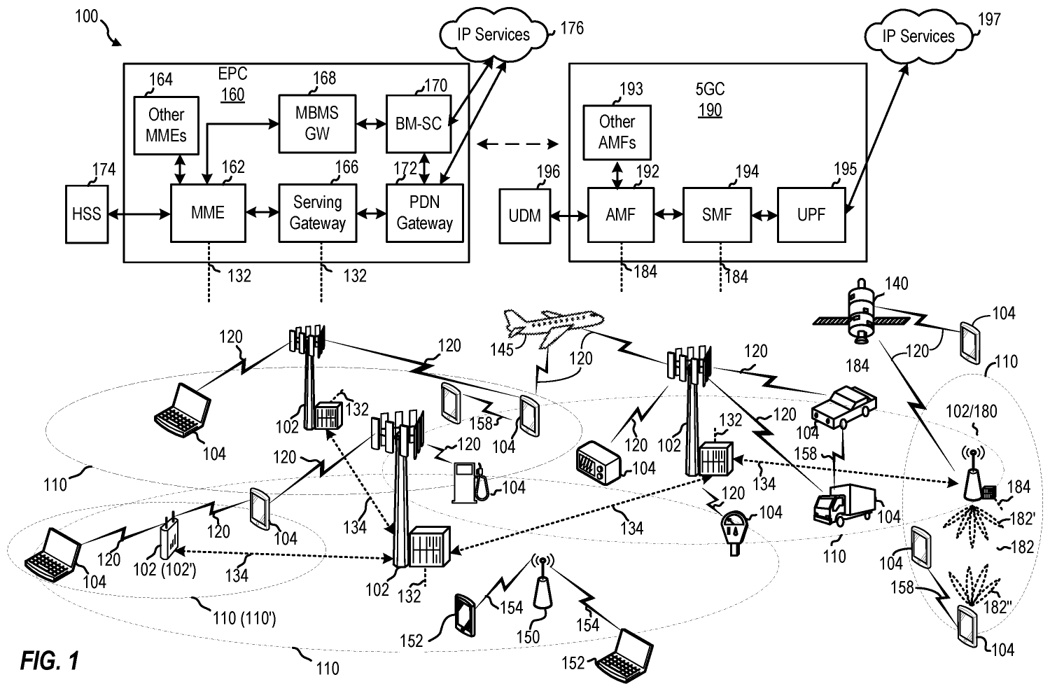

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

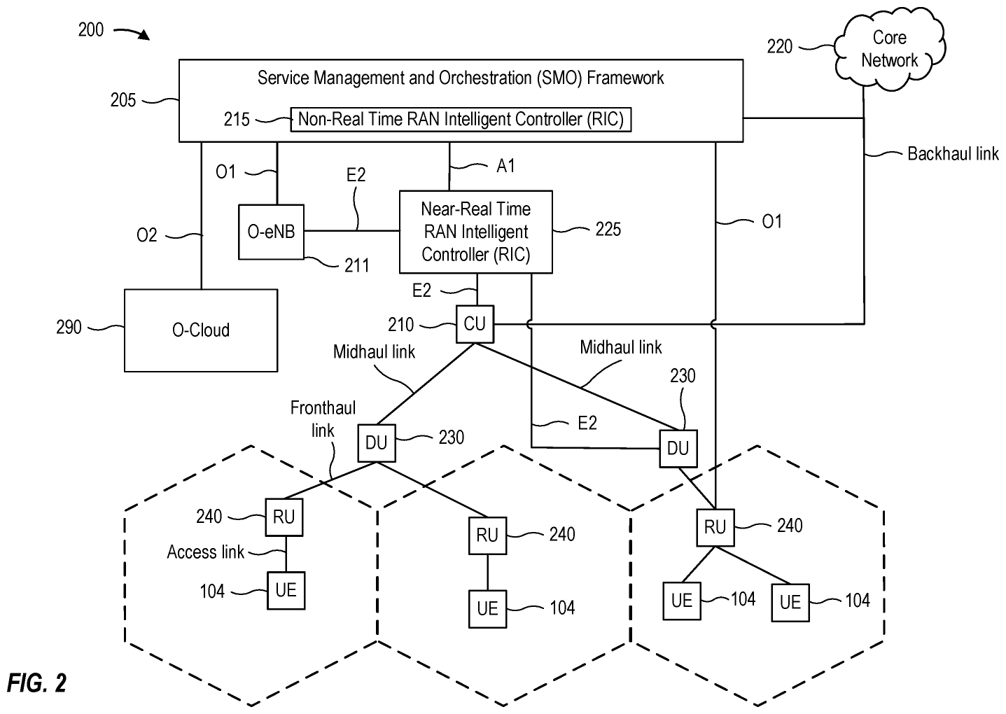

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

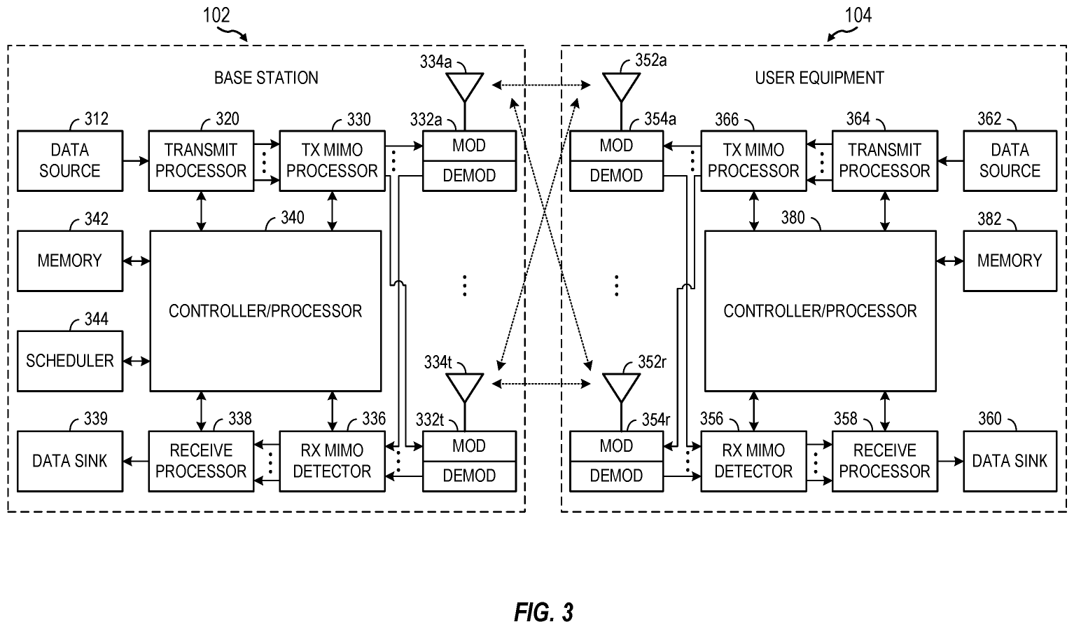

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

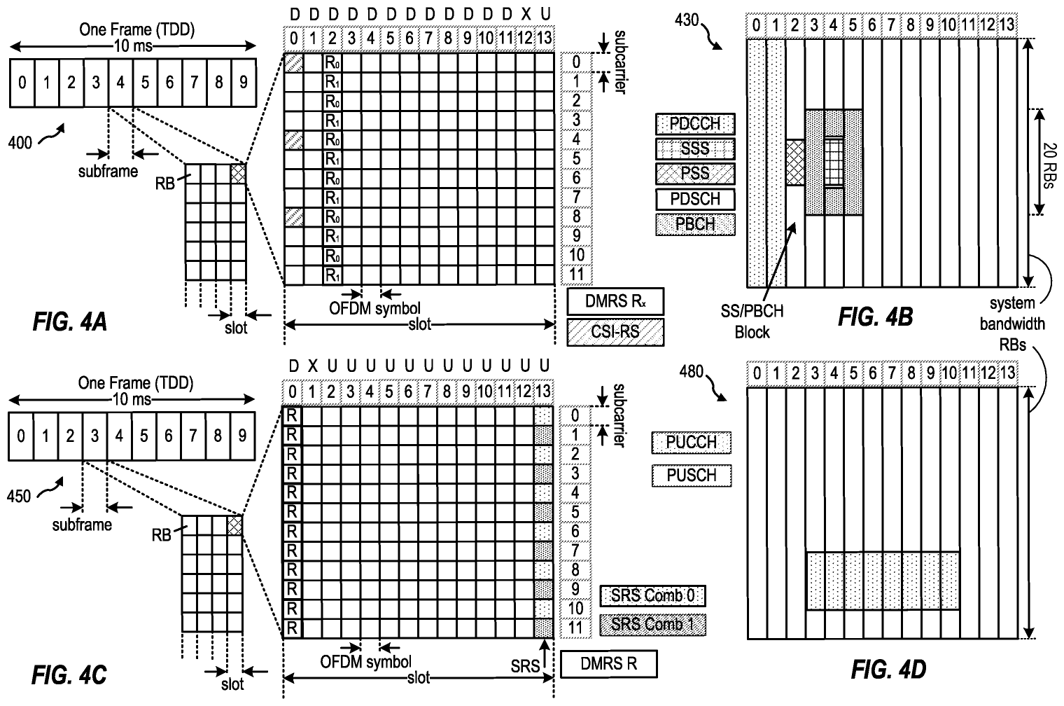

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologics (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to 5G Advanced Applications and Latency-Sensitive Traffic

5G wireless technology provides high-speed, low-latency and high-reliability wireless connectivity which may enable latency-sensitive services like the immersive extended reality (XR) multimedia and cloud computing, such as augmented reality (AR) glasses, virtual reality (VR) Head-Mounted Displays (HMDs), cloud gaming, cloud AI, and other latency-sensitive services. In some cases, to ensure good user experience, these advanced applications may be required to meet strict system requirements including data rate, latency and power consumption. For example, to support low-latency and high-reliability, 99% of packets of XR traffic should be delivered within a packet delay budget (PDB) requirement, such as 10 milliseconds.

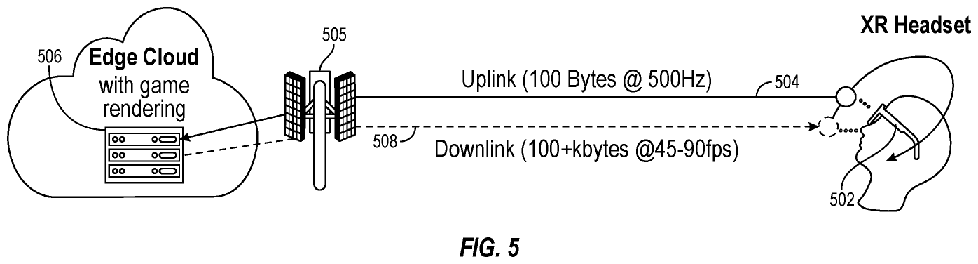

FIG. 5 illustrates an example split XR architecture 500 that may be used to support latency-sensitive services in a 5G NR wireless communications network. For example, as shown, an XR headset 502 may send tracking information in one or more uplink (UL) transmissions 504 to a gNodeB (gNB) 505 of the 5G NR wireless communications network, which may then be provided to cloud-based server 506. As shown, the one or more UL transmissions 504 including the tracking information may include a relatively low throughput (e.g., 100 bytes) but may be transmitted relatively frequently (e.g., 500 hertz). In response to the uplink tracking in the one or more UL transmissions 504, the cloud-based server 506 may render one or more video frames that may be provided to the gNB 505 and sent to the XR headset 502 in one or more downlink (DL) transmissions 508. As shown, while the frequency of the one or more downlink transmissions 508 including the one or more video frames may be lower (e.g., 45-90 frames per second) than transmission of the tracking information in the one or more UL transmissions 504, the throughput of the one or more DL transmissions 508 may be higher (e.g., 100 kilobytes or more).

In some cases, user experience is a function of the total round trip time (RTT) between the one or more UL transmissions 504 including the uplink tracking information and reception of the one or more DL transmissions 508 including the one or more video frames. In some cases, the RTT may need to be below 100 ms for good user experience, which may leave only about 20 ms uplink/downlink 5G portion of the RTT. For example, 100 ms is the total RTT between the XR headset 502 and the cloud-based server 506. This total RTT includes (1) UL transmission from the XR headset 502 to the gNB 505 (including air interface), (2) transmission from gNB 505 to the cloud-based server 506, (3) time for rendering the one or more video frames, (4) transmission from the cloud-based server 506 to gNB 505 of the one or more video frames, and (5) DL transmission from gNB 505 to the XR headset 502 (including air interface). The total time duration associated with steps 2, 3, and 4 is about 80 ms, which leaves only about 20 ms for steps 1 and 5 (e.g., the UL and DL transmission over the air interface).

### Introduction to Measurement Gaps

In 5G NR systems, a UE operating in multi-frequency cellular networks is typically configured with measurement gaps, in which the UE intermittently suspends data transmission to perform radio resource management (RRM) measurements for neighboring cells. A measurement gap generally refers to a duration of time where a UE performs certain RRM measurement procedures.

For example, for an inter-cell measurement procedure, the UE may measure neighboring cells in a multi-cellular network during measurement gaps. In such cases, the UE should measure the neighboring cells and other carrier components using different frequencies. However, many UEs may include a single radio frequency (RF) module to reduce the manufacturing cost and form factor size. As a result, such UEs are unable to perform the inter-frequency measurement while maintaining the data traffic with serving cell.

Various scenarios may be addressed using measurement gaps. For example, measurement gaps may be used for inter-frequency handover (within a same radio access technology/RAT), as well as for inter-RAT handover. In such cases, a UE may measure a target frequency to perform the inter-frequency or inter-RAT handover. During the measurement gap, a UE may temporarily suspend its communication with the serving cell, and measure the inter-frequency. In some cases, measurement gaps may be used in certain operating frequency ranges (e.g., FR2) for a UE to perform a receive (Rx) beam search for intra-frequency handover. In such cases, an FR2 UE Rx beam may be directed towards the serving cell and, during the measurement gap, the UE can temporarily suspend its communication with the serving cell, and redirect its Rx beam towards a target cell. In some cases, a UE configured with an active bandwidth part (BWP) without intra-frequency SSBs may use measurement gaps to temporarily tune its transceiver to a different BWP to receive the intra-frequency SSB.

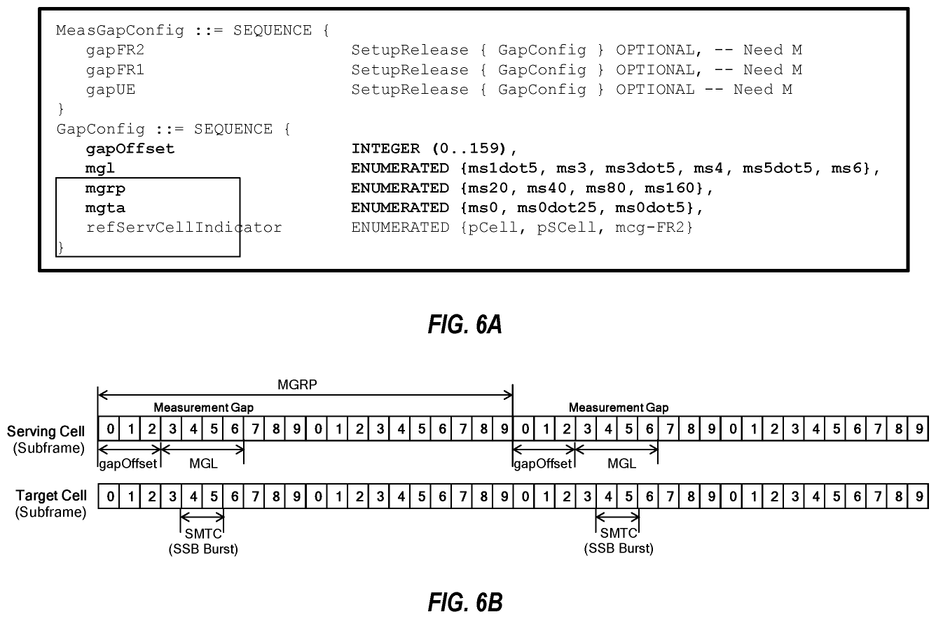

As illustrated in FIG. 6A and FIG. 6B, measurement gaps are typically configured with an offset (e.g., gapOffset), length (e.g., mgl), repetition period (e.g., mgrp), and timing advance (e.g., mgta). The measurement gap may be designed to include a target cell synchronization signal block (SSB) measurement timing configuration (SMTC) as illustrated in FIG. 6B. As such, the measurement gap repetition periodicity must be a multiple of SSB burst periodicity. In the illustrated example, the UE is configured with a 20 ms measurement gap periodicity, 4 ms measurement gap length, which is sufficient to cover a 2 ms target cell SMTC.

In current systems, a measurement gap is typically given automatic priority over data traffic. In such systems, measurement gaps may be given a higher priority than physical downlink shared channel (PDSCH) or physical uplink shared channel (PUSCH) transmissions, except during an initial attach procedure (e.g., for Msg2/Msg3/Msg4 in a 4-step RACH procedure and/or MsgA/MsgB in a 2-step RACH procedure) because it functions to seek out better wireless signaling in a multi-frequency cellular network. For example, the measurement gaps may be given priority over transmissions carrying HARQ feedback, scheduling request (SRs), channel state information (CSI), sounding reference signals (SRSs), non-RACH-based PUSCH, non-RACH-based PDCCH, and non-RACH-based PDSCH. However, RACH-based PUSCH (e.g., for Msg3 and MsgA) and RACH-based PDCCH (e.g., for Msg2, Msg 4, and MsgB) may have priority over the measurement gaps.

As a result, when a measurement gap is configured, maximum UE peak throughput may be reduced according to the measurement gap length. Because of this, in some cases, measurement gaps may only be configured when channel quality of a primary cell becomes less than a certain threshold.

### Aspects Related to Enhanced RRM Measurements for Latency-Sensitive Traffic

As noted above, configured measurement gaps can interrupt the communication (e.g., reception and/or transmission) of bursty data traffic, which may impact the ability to meet PDB requirements. For example, these measurement gaps may be problematic for certain types of traffic, such as multimedia data traffic, that is expected to be delivered within a certain PDB (e.g., 10 ms).

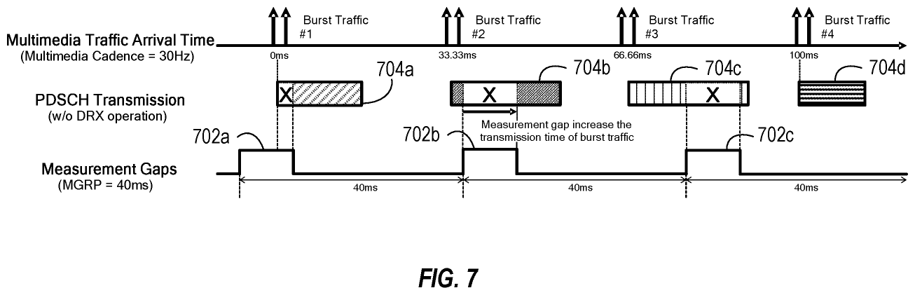

This issue is illustrated in FIG. 7, which shows the potential impact when measurement gaps are placed within the transmission periods for burst traffic. For example, because the measurement gap has a higher priority than the normal data traffic in current systems, the UE may be unable to receive any traffic data (e.g., PDSCH) from the gNB during the measurement gap and its preparation time. Thus, the measurement gap increases the transmission time for burst traffic, making it difficult to meet the PDB requirements of multimedia traffic.

In the illustrated example, burst traffic, such as multimedia burst traffic #1-#4), may be transmitted by a network entity (e.g., gNB) in PDSCH transmission at a 30 Hz cadence (every 33.33 ms). For example, burst traffic #1 may be transmitted in PDSCH transmission 704a, burst traffic #2 may be transmitted in PDSCH transmission 704b, burst traffic #3 may be transmitted in PDSCH transmission 704c, and burst traffic #4 may be transmitted in PDSCH transmission 704d. Further, as shown, a number of measurement gaps (e.g., 702a, 702b, 702c, and 702d) are configured to occur periodically (e.g., every 40 ms) for the UE to perform RRM measurements. However, as shown, these measurement gaps are scheduled to overlap with the PDSCH transmissions (e.g., 704a, 704b, 704c, and 704d), resulting in an increase in transmission time of some of the burst traffic.

For example, measurement gap 702a overlaps with PDSCH transmission 704a used to transmit a first traffic burst, burst traffic #1. The overlap is indicated by the “X” and causes a delay in the start of the transmission of the burst traffic until after the end of the measurement gap 702a. Similarly, measurement gap 702b overlaps with a PDSCH transmission 704b (e.g., carrying burst traffic #2), while measurement gap 702c overlaps with a PDSCH transmission 704c (e.g., carrying burst traffic #3), causing an increase in transmission time of burst traffic #2 and #3. On the other hand, because PDSCH transmission 704d does not overlap with any measurement gap, it may have a shorter duration and delivery of burst traffic #4 may be more likely to stay within its PDB.

In general, a UE may be configured by a serving cell to perform RRM measurements for all neighbor cells to facilitate the UE being handed over to a cell that provides the best coverage for the UE. However, there may be some scenarios in which the UE is configured to measure neighbor cells that are not able to accept a handover of the UE, for example, due to being heavily loaded (e.g., an amount of resources being used at these neighbor cells is greater than a threshold and are not able to serve the UE). In these scenarios, RRM measurements performed by the UE on these neighbor cells would be useless (e.g., since these neighbor cells cannot accept a handover of the UE) and would unnecessarily lead to an increase in the transmission time of the multimedia burst traffic described above, causing this multimedia burst traffic to violate its PDB and leading to poor user experience.

Accordingly, aspects of the present disclosure provide techniques for improving RRM measurements for latency-sensitive traffic, such as the bursty multimedia traffic described above. For example, in some cases, rather that forcing a UE to perform RRM measurements for every neighbor cell, performance of these RRM measurements may be based, for example, on resource status reports of the neighbor cells. More specifically, for example, a network entity of a serving cell may receive one or more resource status reports from one or more neighbor cells of the UE, which may indicate an amount of resources being used at a respective neighbor cell of the one or more neighbor cells from which the resource status reports are received. The network entity of the serving cell may then transmit, to the UE based on the one or more resource status reports received from the one or more neighbor cells, a message indicating an activation status associated with at least one of the RRM measurements or the one or more measurement gaps.

In some cases, the UE may be able to refrain from performing one or more RRM measurements when the activation status indicates that at least one of the RRM measurements or the one or more measurement gaps are deactivated. Deactivating certain RRM measurements and/or measurement gaps may reduce the impacts that the measurement gaps and RRM measurements have on the transmission time of the latency-sensitive bursty traffic and may, thus, improve user experience related to latency-sensitive services. For example, the fewer RRM measurements the UE has to perform, the less often the UE needs the measurement gaps, resulting in the latency-sensitive burst traffic being subject to less interruption time.

### Example Operations of Entities in a Communications Network

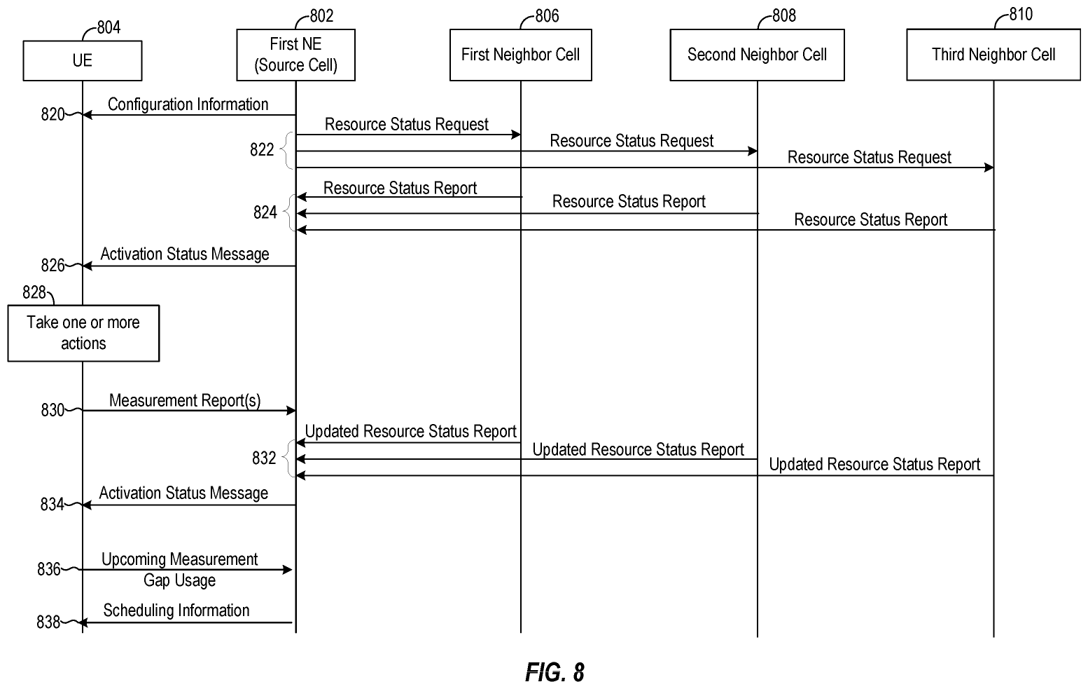

FIG. 8 depicts a process flow including operations 800 for communications in a network between a serving cell 802, a user equipment (UE) 804, and one or more neighbor cells. For example, as shown, the one or more neighbor cells include first neighbor cell 806, a second neighbor cell 808, and a third neighbor cell 810. It should be understood that, while FIG. 8 illustrates three neighbor cells, operations 800 may be used with any number of neighbor cells. In some cases, operations performed by the serving cell 802, the first neighbor cell 806, the second neighbor cell 808, and the third neighbor cell 810 may be performed by one or more respective network entities. For example, operations performed by the serving cell 802 may be performed by a first network entity, operations performed by the first neighbor cell 806 may be performed by a second network entity, operations performed by the second neighbor cell 808 may be performed by a third network entity, operations performed by the third neighbor cell 810 may be performed by a fourth network entity.

In some aspects, the first network entity associated with the serving cell 802, the second network entity associated with the first neighbor cell 806, the third network entity associated with the second neighbor cell 808, and the fourth network entity associated with the third neighbor cell 810 may be examples of the BS 102 depicted and described with respect to FIGS. 1 and 3 or a disaggregated base station depicted and described with respect to FIG. 2. Similarly, the UE 804 may be an example of UE 104 depicted and described with respect to FIGS. 1 and 3.

As shown, operations 800 begin at 820 with the first network entity associated with the serving cell 802 transmitting configuration information to the UE 804. In some cases, the configuration information may be transmitted, for example, in a radio resource control (RRC) reconfiguration message using a connection previously established between the first network entity associated with the serving cell 802 and the UE 804. In some cases, the configuration information may include a measurement configuration (e.g., MeasConfig) indicating one or more neighbor cells for which to perform radio resource management (RRM) measurements. For example, the measurement configuration may configure the UE 804 to perform RRM measurements for first neighbor cell 806, the second neighbor cell 808, and the third neighbor cell 810. In some cases, the configuration information may also indicate a measurement gap configuration (e.g., MeasGap) indicating one or more measurement gaps for performing the RRM measurements.

At 822, the first network entity associated with the serving cell 802 may transmit one or more resource status requests to the one or more neighbor cells, including the first neighbor cell 806, the second neighbor cell 808, and the third neighbor cell 810. The one or more resource status requests may request that each of the one or more neighbor cells transmit a resource status report to the first network entity associated with the serving cell 802.

Thereafter, as shown at 824, the first network entity associated with the serving cell 802 receives one or more resource status reports from the one or more neighbor cells, including the first neighbor cell 806, the second neighbor cell 808, and the third neighbor cell 810. In some cases, each resource status report of the one or more resource status reports indicates an amount of resources being used at a respective neighbor cell of the one or more neighbor cells from which that resource status report is received. For example, the resource status report received from the first neighbor cell 806 may indicate an amount of resources being used at the first neighbor cell 806, the resource status report received from the second neighbor cell 808 may indicate an amount of resources being used at the second neighbor cell 808, and so on. In some cases, the amount of resources may be indicated, for example, as at least one of a percentage of physical resource blocks (PRBs) being used in the DL and/or in the UL at the respective neighbor cell or a percentage of PDCCH control channel elements (CCEs) being used at the respective neighbor cell for scheduling in the DL or in the UL.

As shown at 826, based on the one or more resource status reports received from the one or more neighbor cells, the first network entity associated with the serving cell 802 transmits, to the UE 804, a message indicating an activation status associated with at least one of the RRM measurements or the one or more measurement gaps that were configured by the configuration information received at 820. In some cases, the message

As shown at 828, the UE 804 may take one or more actions based on the message indicating the activation status associated with at least one of the RRM measurements or the one or more measurement gaps.

As shown at 830, the UE 804 may transmit one or more measurement reports to the first network entity associated with the serving cell 802. In some cases, the one or more measurement reports may include RRM measurements for the one or more neighbor cells having activated RRM measurements and/or measurement gaps as indicated by the activation status indicated in the message received by the UE 804 at 826.

In some cases, the activation status associated with at least one of the RRM measurements or the one or more measurement gaps may be based on the amount of resources being used at each respective neighbor cell of the one or more neighbor cells indicated in the one or more resource status report. For example, if a particular neighbor cell transmits a resource status report that indicates an amount of resources being used that is above a threshold amount of resources, the first network entity associated with the serving cell 802 may decide to set activation status of the RRM measurements and/or the measurement gaps associated with that particular neighbor cell to “deactivated” in the message transmitted at 826 since that particular neighbor cell will unlikely be able to serve the UE 804 if the UE 804 were to be handed over to that particular neighbor cell and, thus, RRM measurements associated with that particular neighbor cell would be unnecessary. In such cases, when the RRM measurements or the measurement gaps associated with that particular neighbor cell are deactivated, the UE 804 may refrain from performing the RRM measurements at least for that particular neighbor cell.

In other cases, if the amount of resources being used at the particular neighbor cell is indicated as being less than or equal to the threshold amount of resources, the first network entity associated with the serving cell 802 may decide to set activation status of the RRM measurements and/or the measurement gaps associated with that particular neighbor cell to “activated” in the message transmitted at 826 since that particular neighbor cell has a sufficient amount of resources to serve the UE 804 should the UE 804 be handed over to that particular neighbor cell. In such cases, when the RRM measurements or the measurement gaps associated with that particular neighbor cell are activated, the UE 804 may perform the RRM measurements at least for that particular neighbor cell. Additional details regarding the activation or deactivation of the RRM measurements and/or measurement gaps is provided below.

For example, in some cases, the message received by the UE 804 at 826 may indicate the activation status for the RRM measurements that the UE 804 is configured to perform for the one or more neighbor cells. In some cases, the message indicating the activation status for the RRM measurements comprises one of a media access control-control element (MAC-CE) message or a downlink control information (DCI) message.

In such cases, the activation status for the RRM measurements comprises a different respective indication for each neighbor cell of the one or more neighbor cells indicating whether the RRM measurements associated with that neighbor cell are activated or deactivated. For example, in some cases, the message received at 826 may include a first indication for the first neighbor cell 806 indicating whether the RRM measurements associated with the first neighbor cell 806 are activated or deactivated. The message received at 826 may also include a second indication for the second neighbor cell 808 indicating whether the RRM measurements associated with the second neighbor cell 808 are activated or deactivated, and so on.

In some cases, the different respective indications for each neighbor cell of the one or more neighbor cells may be provided using a plurality of bits in the message received by the UE 804 at 826. For example, each different bit of the plurality of bits may corresponds to a different neighbor cell of the one or more neighbor cells and may indicate the activation status (e.g., activated or deactivated) of the RRM measurements corresponding to that different neighbor cell. For example, a bit value of zero may indicate that the RRM measurements for a corresponding neighbor cell are deactivated while a bit value of one may indicate that the RRM measurements for the corresponding neighbor cell are activated, or vice versa.

As discussed above, in some cases, the different respective indication, corresponding to a particular neighbor cell of the one or more neighbor cells, may indicate (1) that the RRM measurements for that particular neighbor cell are deactivated when the amount of resources being used at that particular neighbor cell are above the threshold amount of resources and (2) that the RRM measurements for that particular neighbor cell are activated when the amount of resources being used at that particular neighbor cell are less than or equal to the threshold amount of resources.

For example, when the first neighbor cell 806 transmits a resource status report to the first network entity associated with the serving cell 802 that indicates that the amount of resources being used at the first neighbor cell 806 is greater than the threshold amount of resources, the message received by the UE 804 at 826 may indicate that the RRM measurements for the first neighbor cell 806 are deactivated. In such cases, taking the one or more actions at 828 may include the UE 804 refraining from performing the RRM measurements for the first neighbor cell 806 when the RRM measurements for the particular neighbor cell are indicated as deactivated.

Alternatively, when the first neighbor cell 806 transmits a resource status report to the first network entity associated with the serving cell 802 that indicates that the amount of resources being used at the first neighbor cell 806 is less than or equal to the threshold amount of resources, the message received by the UE 804 at 826 may indicate that the RRM measurements for the first neighbor cell 806 are activated. In such cases, taking the one or more actions at 828 may include the UE 804 performing the RRM measurements for the first neighbor cell 806 when the RRM measurements for the particular neighbor cell are indicated as activated.

In some cases, the activation status for the RRM measurements indicated in the message received by the UE 804 at 826 may comprise an indication indicating whether the RRM measurements are activated for a particular frequency band or deactivated for the particular frequency band. In such cases, taking the one or more actions at 828 may include the UE 804 performing the RRM measurements for the particular frequency band when the activation status indicates that the RRM measurements are activated for the particular frequency band. Additionally, taking the one or more actions at 828 may include the UE 804 refraining from performing the RRM measurements for the particular frequency band when the activation status indicates that the RRM measurements are deactivated for the particular frequency band.

In some cases, the message received by the UE 804 at 826 may indicate the activation status associated with the one or more measurement gaps that the UE 804 is configured to perform the RRM measurements in for the one or more neighbor cells. In some cases, the message indicating the activation status for the measurement gaps comprises one of a MAC-CE message or a DCI message.

In some cases, the activation status associated with the one or more measurement gaps may comprise a different respective indication for each measurement gap of the one or more measurement gaps indicating whether that measurement gap is activated or deactivated for the RRM measurements. For example, in some cases, the measurement gap configuration received by the UE 804 in the configuration information at 820 may configure the UE 804 with up to eight measurement gaps. In some cases, each measurement gap may be for either an FR1 frequency band, an FR2 frequency band, or per-UE. In such cases, the indicated activation status may include, for example, a first respective indication for a first measurement gap indicating whether the first measurement gap is activated or deactivated, a second respective indication for a second measurement gap indicating whether the second measurement gap is activated or deactivated, and so on.

In some cases, the different respective indications for each measurement gap may be provided using a plurality of bits in the message received by the UE 804 at 826. For example, each different bit of the plurality of bits may corresponds to a different measurement gap of the one or more measurement gaps and may indicate the activation status (e.g., activated or deactivated) of that measurement gap. For example, a bit value of zero may indicate that a corresponding measurement gap is deactivated while a bit value of one may indicate that the corresponding measurement gap is activated, or vice versa.

In some cases, when the different respective indication, corresponding to a particular measurement gap, such as a first measurement gap, indicates that the first measurement gap is activated, the RRM measurements for all neighbor cells, of the one or more neighbor cells, that are associated with the first measurement gap may be activated. In such cases, taking the one or more actions at 828 in FIG. 8 may include the UE 804 performing, during a time period corresponding to the first measurement gap, the RRM measurements for all of the neighbor cells that are associated with the first measurement gap when the different respective indication, corresponding to the first measurement gap, indicates that the first measurement gap is activated. For example, if the first neighbor cell 806, the second neighbor cell 808, and the third neighbor cell 810 are associated with the (activated) first measurement gap, then the UE 804 may be configured to perform the RRM measurements for each of the first neighbor cell 806, the second neighbor cell 808, and the third neighbor cell 810 during a time period corresponding to the first measurement gap.

In some cases, however, when the different respective indication, corresponding to the first measurement gap, indicates that the first measurement gap is deactivated, the RRM measurements for all of the neighbor cells, of the one or more neighbor cells, that are associated with the first measurement gap may be deactivated. In such cases, taking the one or more actions at 828 in FIG. 8 may include the UE 804 refraining from performing, during the time period corresponding to the first measurement gap, the RRM measurements for all of the neighbor cells that are associated with the first measurement gap when the different respective indication, corresponding to the first measurement gap, indicates that the first measurement gap is deactivated. For example, if the first neighbor cell 806 and the second neighbor cell 808 are associated with the (deactivated) first measurement gap, then the UE 804 may be configured to refrain from performing the RRM measurements for each of the first neighbor cell 806 and the second neighbor cell 808 during a time period corresponding to the first measurement gap. Further, if the third neighbor cell 810 is associated with a second measurement gap that is indicated as activated while the first measurement gap is deactivated, the UE 804 may still be configured to perform the RRM measurements for the third neighbor cell 810 during a time period corresponding to the second measurement gap.

In some cases, as shown at 832, the first network entity associated with the serving cell 802 may receive one or more updated resource status reports from the one or more neighbor cells. In some cases, the one or more updated resource status reports may indicate an updated amount of resources being used at each of the one or more neighbor cells. Thereafter, as shown at 834, the first network entity associated with the serving cell 802 may transmit, to the UE based on the one or more updated resource status reports received from the one or more neighbor cells, another message indicating an updated activation status associated with at least one of the RRM measurements or the one or more measurement gaps. The UE 804 may take one or more actions further based on the other message indicating the updated activation status.

For example, in some cases, the resource status report transmitted by the first neighbor cell 806 at 824 may have indicated that the amount of resources being used by the first neighbor cell 806 was above the threshold amount of resources, effectively deactivating the RRM measurements associated with the first neighbor cell 806 at the UE 804. However, in some cases, the message transmitted by the first neighbor cell 806 at 832 may indicate that the amount of resources currently being used by the first neighbor cell 806 is less than or equal to the threshold amount of resources. In such cases, the message transmitted by the first neighbor cell 806 at 824 may update the activation status for the RRM measurements and/or measurement gaps, indicating that the RRM measurements and/or measurement gaps associated with the first neighbor cell 806 are activated. In such cases, the UE 804 may then take action to perform the RRM measurements associated with the first neighbor cell 806. In other cases, if the activation status of the RRM measurements and/or measurement gaps associated with the first neighbor cell 806 is updated to be deactivated, then the UE 804 may take action to refrain from performing the RRM measurements for the first neighbor cell 806.

In some cases, in addition to indicating the activation status associated with the RRM measurements and/or measurement gaps, the UE 804 may also provide signaling to the first network entity associated with the serving cell 802 indicating whether the UE 804 will be using one or more upcoming measurement gaps. This information may, in some cases, be used by the first network entity associated with the serving cell 802 to repurpose upcoming measurement gaps that the UE 804 will not be using for uplink or downlink transmissions, improving resource usage efficiency.

For example, as illustrated at 836 in FIG. 8, the UE 804 transmits, to the network entity associated with the serving cell 802, a message indicating whether the UE 804 will be using one or more upcoming measurement gaps of the one or more measurement gaps configured to be used by the UE 804 for the RRM measurements. In some cases, the message indicating whether the UE 804 will be using the one or more upcoming measurement gaps comprises one of a MAC-CE message or an uplink control information (UCI) message.

In some cases, the message transmitted by the UE at 836 indicating whether the UE will be using the one or more upcoming measurement gaps may include an indication of an identifier (ID) of the measurement gap configuration (e.g., measGapId). In such cases, the message indicating whether the UE will be using the one or more upcoming measurement gaps may include an indication of (1) which upcoming measurement gaps of the measurement gap configuration, corresponding to the indicated ID, that the UE will be using for the RRM measurements and (2) which upcoming measurement gaps of the measurement gap configuration, corresponding to the indicated ID, that the UE will not be using for the RRM measurements. For example, assuming that the indicated identifier is associated with a measurement gap configuration having three measurement gaps. As an example, in such cases, the message transmitted by the UE 804 at 836 may indicate that the UE 804 will be using a first and second measurement gap but will not be using a third measurement gap.

In some cases, the upcoming measurement gaps that the UE 804 will be using for the RRM measurements or will not be using for the RRM measurements may be indicated in different manners. For example, in some cases, the upcoming measurement gaps that the UE 804 will be using for the RRM measurements or will not be using for the RRM measurements may be indicated by an indication of a starting measurement gap and a number of consecutive measurement gaps thereafter. In other cases, the upcoming measurement gaps that the UE 804 will be using for the RRM measurements or will not be using for the RRM measurements may be indicated by a bitmap including a number of bits, each bit corresponding to a different upcoming measurement gaps and indicating whether the UE 804 will or will not be using that measurement gap for the RRM measurements.

Thereafter, as shown at 838, the UE 804 may receive, from the network entity associated with the serving cell 802, scheduling information scheduling uplink or downlink transmissions for the UE 804 during a time period corresponding to the upcoming measurement gaps that the UE will not be using for the RRM measurements. For example, continuing on with the example above, because the UE 804 will not be using the third measurement gap, the network entity associated with the serving cell 802 may decide to repurpose a time period corresponding to the third measurement gap for uplink or downlink signals for the UE 804. Accordingly, in such cases, the UE 804 may receive scheduling information from the first network entity associated with the serving cell 802 that schedules the uplink and/or downlink transmissions for the UE 804 during the timer period corresponding to the third measurement gap.

### Example Operations of a User Equipment

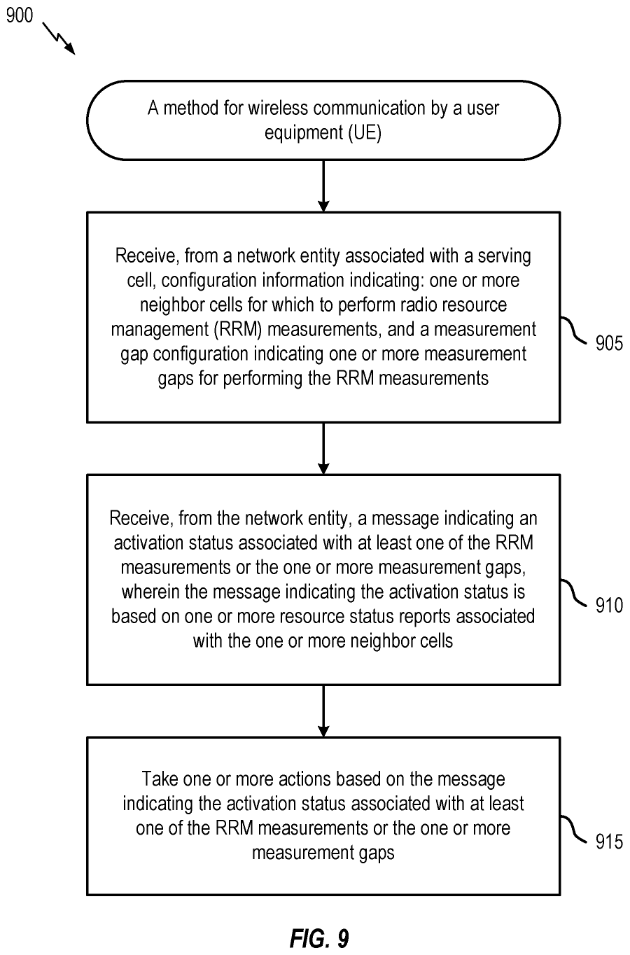

FIG. 9 shows an example of a method 900 of wireless communication by a user equipment (UE), such as a UE 104 of FIGS. 1 and 3.

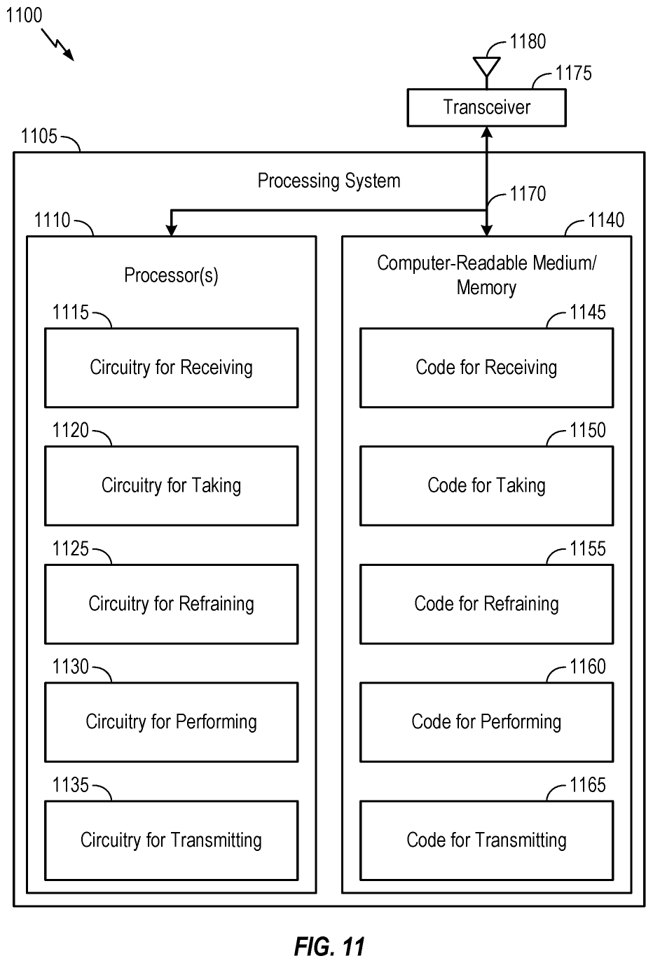

Method 900 begins at step 905 with receiving, from a network entity associated with a serving cell, configuration information indicating: one or more neighbor cells for which to perform radio resource management (RRM) measurements, and a measurement gap configuration indicating one or more measurement gaps for performing the RRM measurements. In some cases, the operations of this step refer to, or may be performed by, circuitry for receiving and/or code for receiving as described with reference to FIG. 11.

Method 900 then proceeds to step 910 with receiving, from the network entity, a message indicating an activation status associated with at least one of the RRM measurements or the one or more measurement gaps, wherein the message indicating the activation status is based on one or more resource status reports associated with the one or more neighbor cells. In some cases, the operations of this step refer to, or may be performed by, circuitry for receiving and/or code for receiving as described with reference to FIG. 11.

Method 900 then proceeds to step 915 with taking one or more actions based on the message indicating the activation status associated with at least one of the RRM measurements or the one or more measurement gaps. In some cases, the operations of this step refer to, or may be performed by, circuitry for taking and/or code for taking as described with reference to FIG. 11.

In some aspects, the activation status associated with at least one of the RRM measurements or the one or more measurement gaps is based on an amount of resources being used at each respective neighbor cell of the one or more neighbor cells.

In some aspects, the message indicates the activation status for the RRM measurements.

In some aspects, the activation status associated with the RRM measurements comprises a different respective indication for each neighbor cell of the one or more neighbor cells indicating whether the RRM measurements associated with that neighbor cell are activated or deactivated.

In some aspects, the different respective indication, corresponding to a particular neighbor cell of the one or more neighbor cells, indicates: the RRM measurements for that particular neighbor cell are deactivated when the amount of resources being used at that particular neighbor cell are above a threshold; and the RRM measurements for that particular neighbor cell are activated when the amount of resources being used at that particular neighbor cell are less than or equal to the threshold.

In some aspects, taking the one or more actions comprises: refraining from performing the RRM measurements for the particular neighbor cell when the RRM measurements for the particular neighbor cell are indicated as deactivated; and performing the RRM measurements for the particular neighbor cell when the RRM measurements for the particular neighbor cell are indicated as activated.

In some aspects, the activation status associated with the RRM measurements comprises and indication indicating whether the RRM measurements are activated for a particular frequency band or deactivated for the particular frequency band; and taking the one or more actions comprises: performing the RRM measurements for the particular frequency band when the activation status indicates that the RRM measurements are activated for the particular frequency band; and refraining from performing the RRM measurements for the particular frequency band when the activation status indicates that the RRM measurements are deactivated for the particular frequency band.

In some aspects, the message indicating the activation status for the RRM measurements comprises one of a media access control-control element (MAC-CE) message or a downlink control information (DCI) message.

In some aspects, the message indicates the activation status associated with the one or more measurement gaps.

In some aspects, the activation status associated with the one or more measurement gaps comprises a different respective indication for each measurement gap of the one or more measurement gaps indicating whether that measurement gap is activated or deactivated for the RRM measurements.

In some aspects, when the different respective indication, corresponding to a first measurement gap, indicates that the first measurement gap is activated, the RRM measurements for all neighbor cells, of the one or more neighbor cells, that are associated with the first measurement gap are activated; and when the different respective indication, corresponding to the first measurement gap, indicates that the first measurement gap is deactivated, the RRM measurements for all neighbor cells, of the one or more neighbor cells, that are associated with the first measurement gap are deactivated.

In some aspects, taking the one or more actions comprises: performing, during a time period corresponding to the first measurement gap, the RRM measurements for all of the neighbor cells that are associated with the first measurement gap when the different respective indication, corresponding to the first measurement gap, indicates that the first measurement gap is activated; and refraining from performing, during the time period corresponding to the first measurement gap, the RRM measurements for all of the neighbor cells that are associated with the first measurement gap when the different respective indication, corresponding to the first measurement gap, indicates that the first measurement gap is deactivated.

In some aspects, the message indicating the activation status associated with the one or more measurement gaps comprises one of a media access control-control element (MAC-CE) message or a downlink control information (DCI) message.

In some aspects, the method 900 further includes transmitting, to the network entity, a message indicating whether the UE will be using one or more upcoming measurement gaps of the one or more measurement gaps. In some cases, the operations of this step refer to, or may be performed by, circuitry for transmitting and/or code for transmitting as described with reference to FIG. 11.

In some aspects, the message indicating whether the UE will be using the one or more upcoming measurement gaps comprises one of a media access control-control element (MAC-CE) message or an uplink control information (UCI) message.

In some aspects, the message indicating whether the UE will be using the one or more upcoming measurement gaps further comprises an indication of an identifier (ID) of the measurement gap configuration.

In some aspects, the message indicating whether the UE will be using the one or more upcoming measurement gaps further comprises an indication of: which upcoming measurement gaps of the measurement gap configuration, corresponding to the indicated ID, that the UE will be using for the RRM measurements; and which upcoming measurement gaps of the measurement gap configuration, corresponding to the indicated ID, that the UE will not be using for the RRM measurements.

In some aspects, the upcoming measurement gaps that the UE will be using for the RRM measurements or will not be using for the RRM measurements are indicated by one of: an indication of a starting measurement gap and a number of consecutive measurement gaps thereafter; or a bitmap including a number of bits, each bit corresponding to a different upcoming measurement gaps and indicating whether the UE will or will not be using that measurement gap for the RRM measurements.

In some aspects, the method 900 further includes receiving, from the network entity, scheduling information scheduling uplink or downlink transmissions for the UE during a time period corresponding to the upcoming measurement gaps that the UE will not be using for the RRM measurements. In some cases, the operations of this step refer to, or may be performed by, circuitry for receiving and/or code for receiving as described with reference to FIG. 11.

In some aspects, the method 900 further includes receiving, from the network entity, another message indicating an updated activation status associated with at least one of the RRM measurements or the one or more measurement gaps, wherein the other message is based on one or more updated resource status reports associated with the one or more neighbor cells, wherein taking the one or more actions is further based on the other message indicating the updated activation status. In some cases, the operations of this step refer to, or may be performed by, circuitry for receiving and/or code for receiving as described with reference to FIG. 11.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Operations of a Network Entity

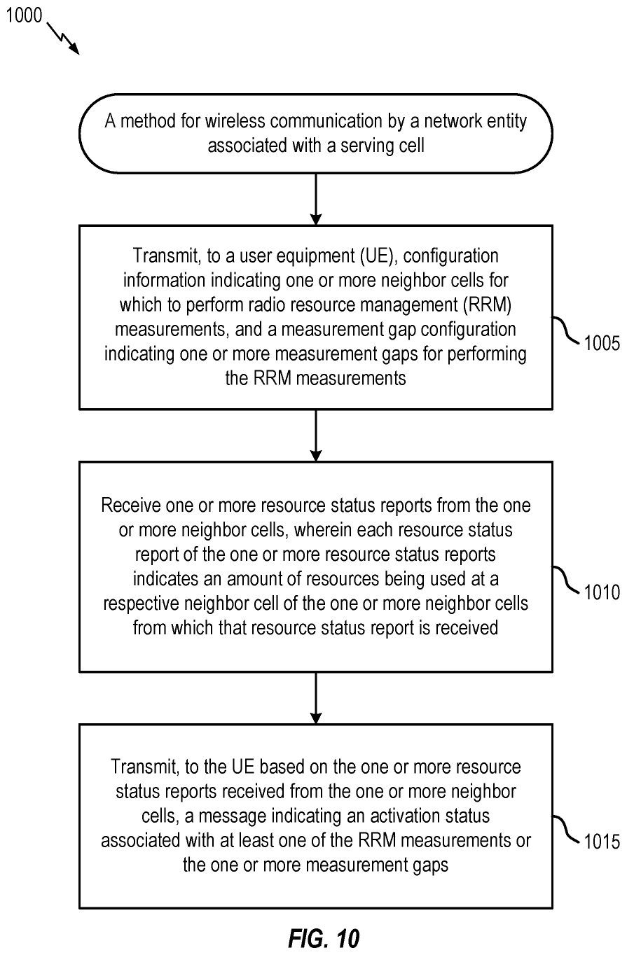

FIG. 10 shows an example of a method 1000 of wireless communication by a network entity associated with a serving cell, such as a BS 102 of FIGS. 1 and 3, or a disaggregated base station as discussed with respect to FIG. 2.

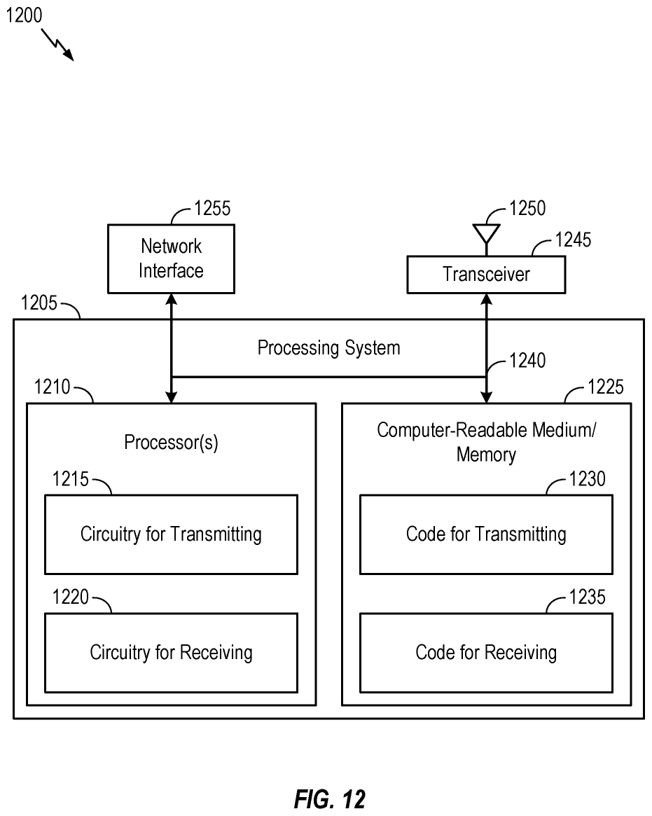

Method 1000 begins at step 1005 with transmitting, to a user equipment (UE), configuration information indicating one or more neighbor cells for which to perform radio resource management (RRM) measurements, and a measurement gap configuration indicating one or more measurement gaps for performing the RRM measurements. In some cases, the operations of this step refer to, or may be performed by, circuitry for transmitting and/or code for transmitting as described with reference to FIG. 12.

Method 1000 then proceeds to step 1010 with receiving one or more resource status reports from the one or more neighbor cells, wherein each resource status report of the one or more resource status reports indicates an amount of resources being used at a respective neighbor cell of the one or more neighbor cells from which that resource status report is received. In some cases, the operations of this step refer to, or may be performed by, circuitry for receiving and/or code for receiving as described with reference to FIG. 12.

Method 1000 then proceeds to step 1015 with transmitting, to the UE based on the one or more resource status reports received from the one or more neighbor cells, a message indicating an activation status associated with at least one of the RRM measurements or the one or more measurement gaps. In some cases, the operations of this step refer to, or may be performed by, circuitry for transmitting and/or code for transmitting as described with reference to FIG. 12.

In some aspects, the activation status associated with at least one of the RRM measurements or the one or more measurement gaps is based on an amount of resources being used at each respective neighbor cell of the one or more neighbor cells indicated in the one or more resource status reports.

In some aspects, the message indicates the activation status for the RRM measurements.

In some aspects, the activation status associated with the RRM measurements comprises a different respective indication for each neighbor cell of the one or more neighbor cells indicating whether the RRM measurements associated with that neighbor cell are activated or deactivated.

In some aspects, the different respective indication, corresponding to a particular neighbor cell of the one or more neighbor cells, indicates: the RRM measurements for that particular neighbor cell are deactivated when the amount of resources being used at that particular neighbor cell are above a threshold; and the RRM measurements for that particular neighbor cell are activated when the amount of resources being used at that particular neighbor cell are less than or equal to the threshold.

In some aspects, the activation status associated with the RRM measurements comprises an indication indicating whether the RRM measurements are activated for a particular frequency band or deactivated for the particular frequency band.

In some aspects, the message indicating the activation status for the RRM measurements comprises one of a media access control-control element (MAC-CE) message or a downlink control information (DCI) message.

In some aspects, the message indicates the activation status associated with the one or more measurement gaps.

In some aspects, the activation status associated with the one or more measurement gaps comprises a different respective indication for each measurement gap of the one or more measurement gaps indicating whether that measurement gap is activated or deactivated for the RRM measurements.

In some aspects, when the different respective indication, corresponding to a first measurement gap, indicates that the first measurement gap is activated, the RRM measurements for all neighbor cells, of the one or more neighbor cells, that are associated with the first measurement gap are activated; and when the different respective indication, corresponding to the first measurement gap, indicates that the first measurement gap is deactivated, the RRM measurements for all neighbor cells, of the one or more neighbor cells, that are associated with the first measurement gap are deactivated.

In some aspects, the message indicating the activation status associated with the one or more measurement gaps comprises one of a media access control-control element (MAC-CE) message or a downlink control information (DCI) message.

In some aspects, the method 1000 further includes receiving, from the UE, a message indicating whether the UE will be using one or more upcoming measurement gaps of the one or more measurement gaps. In some cases, the operations of this step refer to, or may be performed by, circuitry for receiving and/or code for receiving as described with reference to FIG. 12.

In some aspects, the message indicating whether the UE will be using the one or more upcoming measurement gaps comprises one of a media access control-control element (MAC-CE) message or an uplink control information (UCI) message.

In some aspects, the message indicating whether the UE will be using the one or more upcoming measurement gaps further comprises an indication of an identifier (ID) of the measurement gap configuration.

In some aspects, the message indicating whether the UE will be using the one or more upcoming measurement gaps further comprises an indication of: which upcoming measurement gaps of the measurement gap configuration, corresponding to the indicated ID, that the UE will be using for the RRM measurements; and which upcoming measurement gaps of the measurement gap configuration, corresponding to the indicated ID, that the UE will not be using for the RRM measurements.

In some aspects, the upcoming measurement gaps that the UE will be using for the RRM measurements or will not be using for the RRM measurements are indicated by one of: an indication of a starting measurement gap and a number of consecutive measurement gaps thereafter; or a bitmap including a number of bits, each bit corresponding to a different upcoming measurement gaps and indicating whether the UE will or will not be using that measurement gap for the RRM measurements.

In some aspects, the method 1000 further includes transmitting, to the UE, scheduling information scheduling uplink or downlink transmissions for the UE during a time period corresponding to the upcoming measurement gaps that the UE will not be using for the RRM measurements. In some cases, the operations of this step refer to, or may be performed by, circuitry for transmitting and/or code for transmitting as described with reference to FIG. 12.

In some aspects, the method 1000 further includes receiving one or more updated resource status reports from the one or more neighbor cells. In some cases, the operations of this step refer to, or may be performed by, circuitry for receiving and/or code for receiving as described with reference to FIG. 12.

In some aspects, the method 1000 further includes transmitting, to the UE based on the one or more updated resource status reports received from the one or more neighbor cells, another message indicating an updated activation status associated with at least one of the RRM measurements or the one or more measurement gaps. In some cases, the operations of this step refer to, or may be performed by, circuitry for transmitting and/or code for transmitting as described with reference to FIG. 12.

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

### Example Communications Devices

FIG. 11 depicts aspects of an example communications device 1100. In some aspects, communications device 1100 is a user equipment, such as UE 104 described above with respect to FIGS. 1 and 3.

The communications device 1100 includes a processing system 1105 coupled to the transceiver 1175 (e.g., a transmitter and/or a receiver). The transceiver 1175 is configured to transmit and receive signals for the communications device 1100 via the antenna 1180, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1140 via a bus 1170. In certain aspects, the computer-readable medium/memory 1140 is configured to store instructions (e.g., computer-executable code) that when executed by the one or more processors 1110, cause the one or more processors 1110 to perform the method 900 described with respect to FIG. 9, or any aspect related to it. Note that reference to a processor performing a function of communications device 1100 may include one or more processors 1110 performing that function of communications device 1100.

In the depicted example, computer-readable medium/memory 1140 stores code (e.g., executable instructions), such as code for receiving 1145, code for taking 1150, code for refraining 1155, code for performing 1160, and code for transmitting 1165. Processing of the code for receiving 1145, code for taking 1150, code for refraining 1155, code for performing 1160, and code for transmitting 1165 may cause the communications device 1100 to perform the method 900 described with respect to FIG. 9, or any aspect related to it.

The one or more processors 1110 include circuitry configured to implement (e.g., execute) the code stored in the computer-readable medium/memory 1140, including circuitry such as circuitry for receiving 1115, circuitry for taking 1120, circuitry for refraining 1125, circuitry for performing 1130, and circuitry for transmitting 1135. Processing with circuitry for receiving 1115, circuitry for taking 1120, circuitry for refraining 1125, circuitry for performing 1130, and circuitry for transmitting 1135 may cause the communications device 1100 to perform the method 900 described with respect to FIG. 9, or any aspect related to it.

Various components of the communications device 1100 may provide means for performing the method 900 described with respect to FIG. 9, or any aspect related to it. For example, means for transmitting, sending or outputting for transmission may include transceivers 354 and/or antenna(s) 352 of the UE 104 illustrated in FIG. 3 and/or the transceiver 1175 and the antenna 1180 of the communications device 1100 in FIG. 11. Means for receiving or obtaining may include transceivers 354 and/or antenna(s) 352 of the UE 104 illustrated in FIG. 3 and/or the transceiver 1175 and the antenna 1180 of the communications device 1100 in FIG. 11.

FIG. 12 depicts aspects of an example communications device 1200. In some aspects, communications device 1200 is a network entity, such as BS 102 of FIGS. 1 and 3, or a disaggregated base station as discussed with respect to FIG. 2.

The communications device 1200 includes a processing system 1205 coupled to the transceiver 1245 (e.g., a transmitter and/or a receiver) and/or a network interface 1255. The transceiver 1245 is configured to transmit and receive signals for the communications device 1200 via the antenna 1250, such as the various signals as described herein. The network interface 1255 is configured to obtain and send signals for the communications device 1200 via communication link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1225 via a bus 1240. In certain aspects, the computer-readable medium/memory 1225 is configured to store instructions (e.g., computer-executable code) that when executed by the one or more processors 1210, cause the one or more processors 1210 to perform the method 1000 described with respect to FIG. 10, or any aspect related to it. Note that reference to a processor of communications device 1200 performing a function may include one or more processors 1210 of communications device 1200 performing that function.

In the depicted example, the computer-readable medium/memory 1225 stores code (e.g., executable instructions), such as code for transmitting 1230 and code for receiving 1235. Processing of the code for transmitting 1230 and code for receiving 1235 may cause the communications device 1200 to perform the method 1000 described with respect to FIG. 10, or any aspect related to it.

The one or more processors 1210 include circuitry configured to implement (e.g., execute) the code stored in the computer-readable medium/memory 1225, including circuitry such as circuitry for transmitting 1215 and circuitry for receiving 1220. Processing with circuitry for transmitting 1215 and circuitry for receiving 1220 may cause the communications device 1200 to perform the method 1000 described with respect to FIG. 10, or any aspect related to it.

Various components of the communications device 1200 may provide means for performing the method 1000 described with respect to FIG. 10, or any aspect related to it. Means for transmitting, sending or outputting for transmission may include transceivers 332 and/or antenna(s) 334 of the BS 102 illustrated in FIG. 3 and/or the transceiver 1245 and the antenna 1250 of the communications device 1200 in FIG. 12. Means for receiving or obtaining may include transceivers 332 and/or antenna(s) 334 of the BS 102 illustrated in FIG. 3 and/or the transceiver 1245 and the antenna 1250 of the communications device 1200 in FIG. 12.

### EXAMPLE CLAUSES

Implementation examples are described in the following numbered clauses:

Clause 1: A method for wireless communication by a network entity associated with a serving cell, comprising: transmitting, to a user equipment (UE), configuration information indicating one or more neighbor cells for which to perform radio resource management (RRM) measurements, and a measurement gap configuration indicating one or more measurement gaps for performing the RRM measurements; receiving one or more resource status reports from the one or more neighbor cells, wherein each resource status report of the one or more resource status reports indicates an amount of resources being used at a respective neighbor cell of the one or more neighbor cells from which that resource status report is received; and transmitting, to the UE based on the one or more resource status reports received from the one or more neighbor cells, a message indicating an activation status associated with at least one of the RRM measurements or the one or more measurement gaps.

Clause 2: The method of Clause 1, wherein the activation status associated with at least one of the RRM measurements or the one or more measurement gaps is based on an amount of resources being used at each respective neighbor cell of the one or more neighbor cells indicated in the one or more resource status reports.

Clause 3: The method of Clause 2, wherein the message indicates the activation status for the RRM measurements.

Clause 4: The method of Clause 3, wherein the activation status associated with the RRM measurements comprises a different respective indication for each neighbor cell of the one or more neighbor cells indicating whether the RRM measurements associated with that neighbor cell are activated or deactivated.

Clause 5: The method of Clause 4, wherein the different respective indication, corresponding to a particular neighbor cell of the one or more neighbor cells, indicates: the RRM measurements for that particular neighbor cell are deactivated when the amount of resources being used at that particular neighbor cell are above a threshold; and the RRM measurements for that particular neighbor cell are activated when the amount of resources being used at that particular neighbor cell are less than or equal to the threshold.

Clause 6: The method of Clause 3, wherein the activation status associated with the RRM measurements comprises an indication indicating whether the RRM measurements are activated for a particular frequency band or deactivated for the particular frequency band.

Clause 7: The method of Clause 3, wherein the message indicating the activation status for the RRM measurements comprises one of a media access control-control element (MAC-CE) message or a downlink control information (DCI) message.

Clause 8: The method of any one of Clauses 1-7, wherein the message indicates the activation status associated with the one or more measurement gaps.

Clause 9: The method of Clause 8, wherein the activation status associated with the one or more measurement gaps comprises a different respective indication for each measurement gap of the one or more measurement gaps indicating whether that measurement gap is activated or deactivated for the RRM measurements.

Clause 10: The method of Clause 9, wherein: when the different respective indication, corresponding to a first measurement gap, indicates that the first measurement gap is activated, the RRM measurements for all neighbor cells, of the one or more neighbor cells, that are associated with the first measurement gap are activated; and when the different respective indication, corresponding to the first measurement gap, indicates that the first measurement gap is deactivated, the RRM measurements for all neighbor cells, of the one or more neighbor cells, that are associated with the first measurement gap are deactivated.

Clause 11: The method of Clause 9, wherein the message indicating the activation status associated with the one or more measurement gaps comprises one of a media access control-control element (MAC-CE) message or a downlink control information (DCI) message.

Clause 12: The method of any one of Clauses 1-11, further comprising receiving, from the UE, a message indicating whether the UE will be using one or more upcoming measurement gaps of the one or more measurement gaps.

Clause 13: The method of Clause 12, wherein the message indicating whether the UE will be using the one or more upcoming measurement gaps comprises one of a media access control-control element (MAC-CE) message or an uplink control information (UCI) message.

Clause 14: The method of Clause 12, wherein the message indicating whether the UE will be using the one or more upcoming measurement gaps further comprises an indication of an identifier (ID) of the measurement gap configuration.

Clause 15: The method of Clause 12, wherein the message indicating whether the UE will be using the one or more upcoming measurement gaps further comprises an indication of: which upcoming measurement gaps of the measurement gap configuration, corresponding to the indicated ID, that the UE will be using for the RRM measurements; and which upcoming measurement gaps of the measurement gap configuration, corresponding to the indicated ID, that the UE will not be using for the RRM measurements.

Clause 16: The method of Clause 15, wherein the upcoming measurement gaps that the UE will be using for the RRM measurements or will not be using for the RRM measurements are indicated by one of: an indication of a starting measurement gap and a number of consecutive measurement gaps thereafter; or a bitmap including a number of bits, each bit corresponding to a different upcoming measurement gaps and indicating whether the UE will or will not be using that measurement gap for the RRM measurements.

Clause 17: The method of Clause 15, further comprising transmitting, to the UE, scheduling information scheduling uplink or downlink transmissions for the UE during a time period corresponding to the upcoming measurement gaps that the UE will not be using for the RRM measurements.

Clause 18: The method of any one of Clauses 1-17, further comprising: receiving one or more updated resource status reports from the one or more neighbor cells; and transmitting, to the UE based on the one or more updated resource status reports received from the one or more neighbor cells, another message indicating an updated activation status associated with at least one of the RRM measurements or the one or more measurement gaps.

Clause 19: A method for wireless communication by a user equipment (UE), comprising: receiving, from a network entity associated with a serving cell, configuration information indicating: one or more neighbor cells for which to perform radio resource management (RRM) measurements, and a measurement gap configuration indicating one or more measurement gaps for performing the RRM measurements; receiving, from the network entity, a message indicating an activation status associated with at least one of the RRM measurements or the one or more measurement gaps, wherein the message indicating the activation status is based on one or more resource status reports associated with the one or more neighbor cells; and taking one or more actions based on the message indicating the activation status associated with at least one of the RRM measurements or the one or more measurement gaps.

Clause 20: The method of Clause 19, wherein the activation status associated with at least one of the RRM measurements or the one or more measurement gaps is based on an amount of resources being used at each respective neighbor cell of the one or more neighbor cells.

Clause 21: The method of Clause 20, wherein the message indicates the activation status for the RRM measurements.

Clause 22: The method of Clause 21, wherein the activation status associated with the RRM measurements comprises a different respective indication for each neighbor cell of the one or more neighbor cells indicating whether the RRM measurements associated with that neighbor cell are activated or deactivated.

Clause 23: The method of Clause 22, wherein the different respective indication, corresponding to a particular neighbor cell of the one or more neighbor cells, indicates: the RRM measurements for that particular neighbor cell are deactivated when the amount of resources being used at that particular neighbor cell are above a threshold; and the RRM measurements for that particular neighbor cell are activated when the amount of resources being used at that particular neighbor cell are less than or equal to the threshold.

Clause 24: The method of Clause 23, wherein taking the one or more actions comprises: refraining from performing the RRM measurements for the particular neighbor cell when the RRM measurements for the particular neighbor cell are indicated as deactivated; and performing the RRM measurements for the particular neighbor cell when the RRM measurements for the particular neighbor cell are indicated as activated.

Clause 25: The method of Clause 21, wherein: the activation status associated with the RRM measurements comprises and indication indicating whether the RRM measurements are activated for a particular frequency band or deactivated for the particular frequency band; and taking the one or more actions comprises: performing the RRM measurements for the particular frequency band when the activation status indicates that the RRM measurements are activated for the particular frequency band; and refraining from performing the RRM measurements for the particular frequency band when the activation status indicates that the RRM measurements are deactivated for the particular frequency band.

Clause 26: The method of Clause 21, wherein the message indicating the activation status for the RRM measurements comprises one of a media access control-control element (MAC-CE) message or a downlink control information (DCI) message.

Clause 27: The method of any one of Clauses 19-26, wherein the message indicates the activation status associated with the one or more measurement gaps.

Clause 28: The method of Clause 27, wherein the activation status associated with the one or more measurement gaps comprises a different respective indication for each measurement gap of the one or more measurement gaps indicating whether that measurement gap is activated or deactivated for the RRM measurements.

Clause 29: The method of Clause 28, wherein: when the different respective indication, corresponding to a first measurement gap, indicates that the first measurement gap is activated, the RRM measurements for all neighbor cells, of the one or more neighbor cells, that are associated with the first measurement gap are activated; and when the different respective indication, corresponding to the first measurement gap, indicates that the first measurement gap is deactivated, the RRM measurements for all neighbor cells, of the one or more neighbor cells, that are associated with the first measurement gap are deactivated.

Clause 30: The method of Clause 29, wherein taking the one or more actions comprises: performing, during a time period corresponding to the first measurement gap, the RRM measurements for all of the neighbor cells that are associated with the first measurement gap when the different respective indication, corresponding to the first measurement gap, indicates that the first measurement gap is activated; and refraining from performing, during the time period corresponding to the first measurement gap, the RRM measurements for all of the neighbor cells that are associated with the first measurement gap when the different respective indication, corresponding to the first measurement gap, indicates that the first measurement gap is deactivated.

Clause 31: The method of Clause 28, wherein the message indicating the activation status associated with the one or more measurement gaps comprises one of a media access control-control element (MAC-CE) message or a downlink control information (DCI) message.

Clause 32: The method of any one of Clauses 19-31, further comprising transmitting, to the network entity, a message indicating whether the UE will be using one or more upcoming measurement gaps of the one or more measurement gaps.

Clause 33: The method of Clause 32, wherein the message indicating whether the UE will be using the one or more upcoming measurement gaps comprises one of a media access control-control element (MAC-CE) message or an uplink control information (UCI) message.

Clause 34: The method of Clause 32, wherein the message indicating whether the UE will be using the one or more upcoming measurement gaps further comprises an indication of an identifier (ID) of the measurement gap configuration.

Clause 35: The method of Clause 32, wherein the message indicating whether the UE will be using the one or more upcoming measurement gaps further comprises an indication of: which upcoming measurement gaps of the measurement gap configuration, corresponding to the indicated ID, that the UE will be using for the RRM measurements; and which upcoming measurement gaps of the measurement gap configuration, corresponding to the indicated ID, that the UE will not be using for the RRM measurements.

Clause 36: The method of Clause 35, wherein the upcoming measurement gaps that the UE will be using for the RRM measurements or will not be using for the RRM measurements are indicated by one of: an indication of a starting measurement gap and a number of consecutive measurement gaps thereafter; or a bitmap including a number of bits, each bit corresponding to a different upcoming measurement gaps and indicating whether the UE will or will not be using that measurement gap for the RRM measurements.

Clause 37: The method of Clause 35, further comprising receiving, from the network entity, scheduling information scheduling uplink or downlink transmissions for the UE during a time period corresponding to the upcoming measurement gaps that the UE will not be using for the RRM measurements.

Clause 38: The method of any one of Clauses 19-37, further comprising receiving, from the network entity, another message indicating an updated activation status associated with at least one of the RRM measurements or the one or more measurement gaps, wherein the other message is based on one or more updated resource status reports associated with the one or more neighbor cells, wherein taking the one or more actions is further based on the other message indicating the updated activation status.

Clause 39: An apparatus, comprising: at least one memory comprising executable instructions; and at least one processor configured to execute the executable instructions and cause the apparatus to perform a method in accordance with any one of Clauses 1-38.

Clause 40: An apparatus, comprising means for performing a method in accordance with any one of Clauses 1-38.

Clause 41: A non-transitory computer-readable medium comprising executable instructions that, when executed by at least one processor of an apparatus, cause the apparatus to perform a method in accordance with any one of Clauses 1-38.

Clause 42: A computer program product embodied on a computer-readable storage medium comprising code for performing a method in accordance with any one of Clauses 1-38.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication by a network entity associated with a serving cell, comprising:
one or more processors configured to execute instructions stored on one or more memories and to cause the network entity to:
transmit, to a user equipment (UE), configuration information indicating:
one or more neighbor cells for which to perform radio resource management (RRM) measurements; and
a measurement gap configuration indicating one or more measurement gaps for performing the RRM measurements;
receive one or more resource status reports from the one or more neighbor cells, wherein each resource status report of the one or more resource status reports indicates an amount of resources being used at a respective neighbor cell of the one or more neighbor cells from which that resource status report is received; and
transmit, to the UE based on the one or more resource status reports received from the one or more neighbor cells, a message indicating an activation status associated with at least one of the RRM measurements or the one or more measurement gaps.

2. The apparatus of claim 1, wherein the activation status associated with at least one of the RRM measurements or the one or more measurement gaps is based on an amount of resources being used at each respective neighbor cell of the one or more neighbor cells indicated in the one or more resource status reports.

3. The apparatus of claim 2, wherein the message indicates the activation status for the RRM measurements.

4. The apparatus of claim 3, wherein the activation status for the RRM measurements comprises a different respective indication for each neighbor cell of the one or more neighbor cells indicating whether the RRM measurements associated with that neighbor cell are activated or deactivated.

5. The apparatus of claim 4, wherein the different respective indication, corresponding to a particular neighbor cell of the one or more neighbor cells, indicates:
the RRM measurements for that particular neighbor cell are deactivated when the amount of resources being used at that particular neighbor cell are above a threshold; and
the RRM measurements for that particular neighbor cell are activated when the amount of resources being used at that particular neighbor cell are less than or equal to the threshold.

6. The apparatus of claim 3, wherein the activation status for the RRM measurements comprises an indication indicating whether the RRM measurements are activated for a particular frequency band or deactivated for the particular frequency band.

7. The apparatus of claim 1, wherein:
the message indicates the activation status associated with the one or more measurement gaps; and
the activation status associated with the one or more measurement gaps comprises a different respective indication for each measurement gap of the one or more measurement gaps indicating whether that measurement gap is activated or deactivated for the RRM measurements.

8. The apparatus of claim 7, wherein:
when the different respective indication, corresponding to a first measurement gap, indicates that the first measurement gap is activated, the RRM measurements for all neighbor cells, of the one or more neighbor cells, that are associated with the first measurement gap are activated; and
when the different respective indication, corresponding to the first measurement gap, indicates that the first measurement gap is deactivated, the RRM measurements for all neighbor cells, of the one or more neighbor cells, that are associated with the first measurement gap are deactivated.

9. The apparatus of claim 1, wherein the one or more processors are further configured to cause the network entity to:
receive, from the UE, a message indicating whether the UE will be using one or more upcoming measurement gaps of the one or more measurement gaps, wherein the message indicating whether the UE will be using the one or more upcoming measurement gaps further comprises an indication of an identifier (ID) of the measurement gap configuration.

10. The apparatus of claim 9, wherein the message indicating whether the UE will be using the one or more upcoming measurement gaps further comprises an indication of:
which upcoming measurement gaps of the measurement gap configuration, corresponding to the indicated ID, that the UE will be using for the RRM measurements; and
which upcoming measurement gaps of the measurement gap configuration, corresponding to the indicated ID, that the UE will not be using for the RRM measurements.

11. The apparatus of claim 10, wherein the upcoming measurement gaps that the UE will be using for the RRM measurements or will not be using for the RRM measurements are indicated by one of:
an indication of a starting measurement gap and a number of consecutive measurement gaps thereafter; or
a bitmap including a number of bits, each bit corresponding to a different upcoming measurement gaps and indicating whether the UE will or will not be using that measurement gap for the RRM measurements.

12. The apparatus of claim 10, wherein the one or more processors are further configured to cause the network entity to transmit, to the UE, scheduling information scheduling uplink or downlink transmissions for the UE during a time period corresponding to the upcoming measurement gaps that the UE will not be using for the RRM measurements.

13. The apparatus of claim 1, wherein the one or more processors are further configured to cause the network entity to:
receive one or more updated resource status reports from the one or more neighbor cells; and
transmit, to the UE based on the one or more updated resource status reports received from the one or more neighbor cells, another message indicating an updated activation status associated with at least one of the RRM measurements or the one or more measurement gaps.

14. An apparatus for wireless communication by a user equipment (UE), comprising:
one or more processors configured to execute instructions stored on one or more memories and to cause the UE to:
receive, from a network entity associated with a serving cell, configuration information indicating:
one or more neighbor cells for which to perform radio resource management (RRM) measurements; and
a measurement gap configuration indicating one or more measurement gaps for performing the RRM measurements;
receive, from the network entity, a message indicating an activation status associated with at least one of the RRM measurements or the one or more measurement gaps, wherein the message indicating the activation status is based on one or more resource status reports associated with the one or more neighbor cells; and
take one or more actions based on the message indicating the activation status associated with at least one of the RRM measurements or the one or more measurement gaps.

15. The apparatus of claim 14, wherein the activation status associated with at least one of the RRM measurements or the one or more measurement gaps is based on an amount of resources being used at each respective neighbor cell of the one or more neighbor cells.

16. The apparatus of claim 15, wherein the message indicates the activation status for the RRM measurements.

17. The apparatus of claim 16, wherein the activation status for the RRM measurements comprises a different respective indication for each neighbor cell of the one or more neighbor cells indicating whether the RRM measurements associated with that neighbor cell are activated or deactivated.

18. The apparatus of claim 17, wherein the different respective indication, corresponding to a particular neighbor cell of the one or more neighbor cells, indicates:
the RRM measurements for that particular neighbor cell are deactivated when the amount of resources being used at that particular neighbor cell are above a threshold; and
the RRM measurements for that particular neighbor cell are activated when the amount of resources being used at that particular neighbor cell are less than or equal to the threshold.

19. The apparatus of claim 18, wherein, in order to take the one or more actions, the one or more processors are configured to cause the UE to:
refrain from performing the RRM measurements for the particular neighbor cell when the RRM measurements for the particular neighbor cell are indicated as deactivated; and
perform the RRM measurements for the particular neighbor cell when the RRM measurements for the particular neighbor cell are indicated as activated.

20. The apparatus of claim 16, wherein:
the activation status for the RRM measurements comprises an indication indicating whether the RRM measurements are activated for a particular frequency band or deactivated for the particular frequency band; and
in order to take the one or more actions, the one or more processors are configured to cause the UE to:
perform the RRM measurements for the particular frequency band when the activation status indicates that the RRM measurements are activated for the particular frequency band; and
refrain from performing the RRM measurements for the particular frequency band when the activation status indicates that the RRM measurements are deactivated for the particular frequency band.

21. The apparatus of claim 14, wherein:
the message indicates the activation status associated with the one or more measurement gaps; and
the activation status associated with the one or more measurement gaps comprises a different respective indication for each measurement gap of the one or more measurement gaps indicating whether that measurement gap is activated or deactivated for the RRM measurements.

22. The apparatus of claim 21, wherein:
when the different respective indication, corresponding to a first measurement gap, indicates that the first measurement gap is activated, the RRM measurements for all neighbor cells, of the one or more neighbor cells, that are associated with the first measurement gap are activated; and
when the different respective indication, corresponding to the first measurement gap, indicates that the first measurement gap is deactivated, the RRM measurements for all neighbor cells, of the one or more neighbor cells, that are associated with the first measurement gap are deactivated.

23. The apparatus of claim 22, wherein, in order to take the one or more actions, the one or more processors are configured to cause the UE to:
perform, during a time period corresponding to the first measurement gap, the RRM measurements for all of the neighbor cells that are associated with the first measurement gap when the different respective indication, corresponding to the first measurement gap, indicates that the first measurement gap is activated; and
refrain from performing, during the time period corresponding to the first measurement gap, the RRM measurements for all of the neighbor cells that are associated with the first measurement gap when the different respective indication, corresponding to the first measurement gap, indicates that the first measurement gap is deactivated.

24. The apparatus of claim 14, wherein the one or more processors are further configured to cause the UE to transmit, to the network entity, a message indicating whether the UE will be using one or more upcoming measurement gaps of the one or more measurement gaps, wherein the message indicating whether the UE will be using the one or more upcoming measurement gaps further comprises an indication of an identifier (ID) of the measurement gap configuration.

25. The apparatus of claim 24, wherein the message indicating whether the UE will be using the one or more upcoming measurement gaps further comprises an indication of:
which upcoming measurement gaps of the measurement gap configuration, corresponding to the indicated ID, that the UE will be using for the RRM measurements; and
which upcoming measurement gaps of the measurement gap configuration, corresponding to the indicated ID, that the UE will not be using for the RRM measurements.

26. The apparatus of claim 25, wherein the upcoming measurement gaps that the UE will be using for the RRM measurements or will not be using for the RRM measurements are indicated by one of:
an indication of a starting measurement gap and a number of consecutive measurement gaps thereafter; or
a bitmap including a number of bits, each bit corresponding to a different upcoming measurement gaps and indicating whether the UE will or will not be using that measurement gap for the RRM measurements.

27. The apparatus of claim 25, wherein the one or more processors are further configured to cause the UE to receive, from the network entity, scheduling information scheduling uplink or downlink transmissions for the UE during a time period corresponding to the upcoming measurement gaps that the UE will not be using for the RRM measurements.

28. The apparatus of claim 14, wherein:
the one or more processors are further configured to cause the UE to receive, from the network entity, another message indicating an updated activation status associated with at least one of the RRM measurements or the one or more measurement gaps;
the other message is based on one or more updated resource status reports associated with the one or more neighbor cells; and
the one or more processors are configured to cause the UE to take the one or more actions further based on the other message indicating the updated activation status.

29. A method for wireless communication by a network entity associated with a serving cell, comprising:
transmitting, to a user equipment (UE), configuration information indicating:
one or more neighbor cells for which to perform radio resource management (RRM) measurements; and
a measurement gap configuration indicating one or more measurement gaps for performing the RRM measurements;
receiving one or more resource status reports from the one or more neighbor cells, wherein each resource status report of the one or more resource status reports indicates an amount of resources being used at a respective neighbor cell of the one or more neighbor cells from which that resource status report is received; and
transmitting, to the UE based on the one or more resource status reports received from the one or more neighbor cells, a message indicating an activation status associated with at least one of the RRM measurements or the one or more measurement gaps.

30. A method for wireless communication by a user equipment (UE), comprising:
receiving, from a network entity associated with a serving cell, configuration information indicating:
one or more neighbor cells for which to perform radio resource management (RRM) measurements; and
a measurement gap configuration indicating one or more measurement gaps for performing the RRM measurements;
receiving, from the network entity, a message indicating an activation status associated with at least one of the RRM measurements or the one or more measurement gaps, wherein the message indicating the activation status is based on one or more resource status reports associated with the one or more neighbor cells; and
taking one or more actions based on the message indicating the activation status associated with at least one of the RRM measurements or the one or more measurement gaps.
